(19) United States
(12) Patent Application Publication
(10) Pub. No.: US 2010/0040306 A1
(43) Pub. Date: Feb. 18, 2010

(54) IMAGE PROCESSING METHOD AND IMAGE PROCESSING APPARATUS

(76) Inventors: Kenichi Morioka, Tokyo (JP); Shingo Kazuma, Tokyo (JP)

Correspondence Address: TAFT, STETTINIUS & HOLLISTER LLP, SUITE 1800, 425 WALNUT STREET, CINCINNATI, OH, 45202-3957, US

(21) Appl. No.: 12/511,433

(22) Filed: Jul. 29, 2009

(30) Foreign Application Priority Data
Aug. 13, 2008 (JP) 2008-208611

(51) Int. Cl. G06K 9/36

(52) U.S. Cl. 382/284

(57) ABSTRACT

There is provided an image processing method for acquiring a partial image a target and constructing one whole image of the target. The acquired partial image is stored in a first storage section. A movement amount of an image is calculated using a previous partial image and a latest partial image. A partial image having a minimum difference from the latest partial image in an overlapping portion therebetween is stored in a second storage section. The partial image having the minimum difference as the latest partial image in the first storage section is stored when it is determined that the calculated movement amount is more than the predetermined value.

### CROSS-REFERENCE TO RELATED APPLICATIONS

This application claims priority under 35 U.S.C. §119 from Japanese Patent Application No. 2008-208611 filed on Aug. 13, 2008, the disclosure of which is incorporated by reference herein.

### RELATED ART

1. Field of the Invention

The present disclosure relates to an image processing method and an image processing apparatus and, more particularly, to a technique for using partial images acquired by a slide-type line sensor to construct one whole image in, for example, fingerprint authentication.

2. Description of the Related Art

In recent years, a fingerprint authentication system, which is one of image processing apparatuses, has used an area sensor or a line sensor in order to acquire a fingerprint image. When the area sensor is used, the whole fingerprint image can be obtained by one read operation. In contrast, in the case of the line sensor, when a user slides the user's finger on the line sensor, the line sensor continuously acquires a plurality of strip-shaped partial images (hereinafter, referred to as “slice images”) divided from a fingerprint.

FIGS. 2A and 2B are diagrams schematically illustrating the reading of a fingerprint by the line sensor according to the related art. FIG. 2A is a plan view, and FIG. 2B is a cross-sectional view.

In the apparatus, a rod-shaped line sensor 1 is provided on the upper surface of a fingerprint recognizing device 2. When a finger 3 slides on the line sensor 1, the line sensor 1 continuously reads the fingerprint slice images of the finger 3, and transmits the read images to the fingerprint recognizing device 2. The fingerprint recognizing device 2 superimposes a plurality of slice images to construct one whole fingerprint image, and checks whether the image of the fingerprint is identical to the fingerprint of the user. As such, when the line sensor 2 is used, it is known that costs and an installation area can be reduced, as compared to the area sensor.

For example, as the method for forming the whole image using the slice images, Japanese Patent Application Laid-Open (JP-A) No. 2003-248820 discloses a method for superimposing a plurality of slice images to construct one whole fingerprint image (hereinafter, referred to as a “stitch process”).

JP-A No. 2003-248820 discloses an image connecting method for generating one whole fingerprint image as described below. In the method, when a finger is moved relative to a line sensor, the slice image of the finger print is continuously input. Characteristic shapes, such as a ridge shape, an edge line, and a portion that varies greatly in the tangential direction, are extracted from the slice image. A common region in which the characteristic shapes of two slice images that are temporally adjacent to each other are identical to each other is searched by the correlation between the characteristic shapes and a movement amount between the images in an overlapping portion therebetween is detected. The stitch process is performed on the two slice images that are temporally adjacent to each other, based on the movement amount. That is, in the stitch process, when the slice images overlap each other, an overlapping position between pixels is searched. The difference between the images in the overlapping portion is calculated while changing the overlapping position one pixel by one pixel. The position where the difference between the images in the overlapping portion is the minimum is used as the overlapping position.

### Introduction to the Invention

The present disclosure has been made in view of the above circumstances and provides an image processing method and an image processing apparatus.

According to an aspect of the disclosure, there is provided an image processing method for acquiring a partial image of a target and constructing one whole image of the target, including: storing the acquired partial image in a first storage section; calculating a movement amount of an image using a previous partial image stored in the first storage section and a latest partial image stored in the first storage section; storing a partial image having a minimum difference from the latest partial image in an overlapping portion therebetween in a second storage section; determining whether the calculated movement amount is more than a predetermined value; and storing the partial image having the minimum difference as the latest partial image in the first storage section when it is determined that the calculated movement amount is more than the predetermined value.

According to another aspect of the disclosure, there is provided an image processing method for acquiring a partial image of a target and constructing one whole image of the target, including: storing the acquired partial image in a storage section; and calculating a movement amount of an image using lines that are separated from each other in an overlapping portion between a previous partial image stored in the storage section and a latest partial image stored in the storage section.

According to another aspect of the disclosure,there is provided an image processing method for acquiring a partial image of a-target and constructing one whole image the target, including: storing the acquired partial image in a storage section; calculating a movement amount of an image using a previous partial image stored in the storage section and a latest partial image stored in the storage section; changing an operation mode to a mode that does not perform decimation when the calculated movement amount is more than a predetermined value; and changing the operation mode to a mode that performs decimation when the movement amount is continuously less than the predetermined value in the mode that does not perform decimation.

According to another aspect of the disclosure, there is provided an image processing apparatus for acquiring a partial image of a target and constructing one whole image of the target, including: a first storage section that stores the acquired partial image; an image movement amount calculation section that calculates a movement amount of an image using a previous partial image stored in the first storage section and a latest partial image stored in the first storage section; a second storage section that stores a partial image having a minimum difference from the latest partial image in an overlapping portion therebetween; and a determination section that determines whether the calculated movement amount is more than a predetermined value, and stores the partial image having the minimum difference as the latest partial image in the first storage section when it is determined that the calculated movement amount is more than the predetermined value.

According to another aspect of the disclosure, there is provided an image processing apparatus for acquiring a partial image of a target and constructing one whole image of the target, including: a storage section that stores the acquired partial image; and an image movement amount calculation section that calculates a movement amount of an image using lines that are separated from each other in an overlapping portion between a previous partial image stored in the storage section and a latest partial image stored in the storage section.

According to another aspect of the disclosure, there is provided an image processing apparatus for acquiring a partial image of a target and constructing one whole image of the target, including: a storage section that stores the acquired partial image; an image movement amount calculation section that calculates a movement amount of an image using a previous partial image stored in the storage section and a latest partial image stored in the storage section; a first mode change section that changes an operation mode to a mode that does not perform decimation when the calculated movement amount is more than a predetermined value; and a second mode change section that changes the operation mode to a mode that performs decimation when the movement amount is continuously less than the predetermined value in the mode that does not perform decimation.

### BRIEF DESCRIPTION OF THE DRAWINGS

Exemplary embodiments of the present disclosure will be described based on the following figures, wherein:

FIG. 1 is a diagram schematically illustrating the structure of a fingerprint reader, which is one of image processing apparatuses according to a first embodiment of the present disclosure;

FIGS. 2A and 2B are diagrams schematically illustrating the reading of a fingerprint by a line sensor according to the related art;

FIG. 3 is a diagram illustrating deviation and the deterioration of image quality in the related art;

FIGS. 4A and 4B are diagrams illustrating the relationship between deviation and the difference between images in an overlapping portion;

FIG. 5 is a diagram illustrating the outline of a decimation process according to the related technique;

FIG. 6 is a diagram illustrating a method for selecting a slice image;

FIG. 7 is a diagram illustrating a method for calculating a movement amount according to the related technique;

FIG. 8 is a diagram illustrating the decimation process when the movement amount is large according to the related technique;

FIG. 9 is a diagram illustrating an example of a method for calculating a movement amount according to the first embodiment;

FIG. 10 is a diagram illustrating a decimation process when the movement amount is large according to the first embodiment;

FIG. 11 is a flowchart illustrating the procedure of the decimation process of the fingerprint reader shown in FIG. 1;

FIG. 12 is a flowchart illustrating the procedure of stitch input determination (Step S2) in the decimation process shown in FIG. 11;

FIG. 13 is a diagram illustrating a method for calculating the movement amount between two slice images (Step S21) in FIG. 12;

FIG. 14 is a flowchart illustrating the procedure of a mode selection process (Step S22) in FIG. 12; and

FIG. 15 is a flowchart illustrating the procedure of a minimum difference selection process (Step S23) in FIG. 12.

### DETAILED DESCRIPTION

The exemplary embodiments of the present disclosure are described and illustrated below to encompass image processing methods and image processing apparatuses. Of course, it will be apparent to those of ordinary skill in the art that the preferred embodiments discussed below are exemplary in nature and may be reconfigured without departing from the scope and spirit of the present invention. However, for clarity and precision, the exemplary embodiments as discussed below may include optional steps, methods, and features that one of ordinary skill should recognize as not being a requisite to fall within the scope of the present disclosure. It should be noted that the drawings are solely for description and are not to limit the technical scope of the present invention.

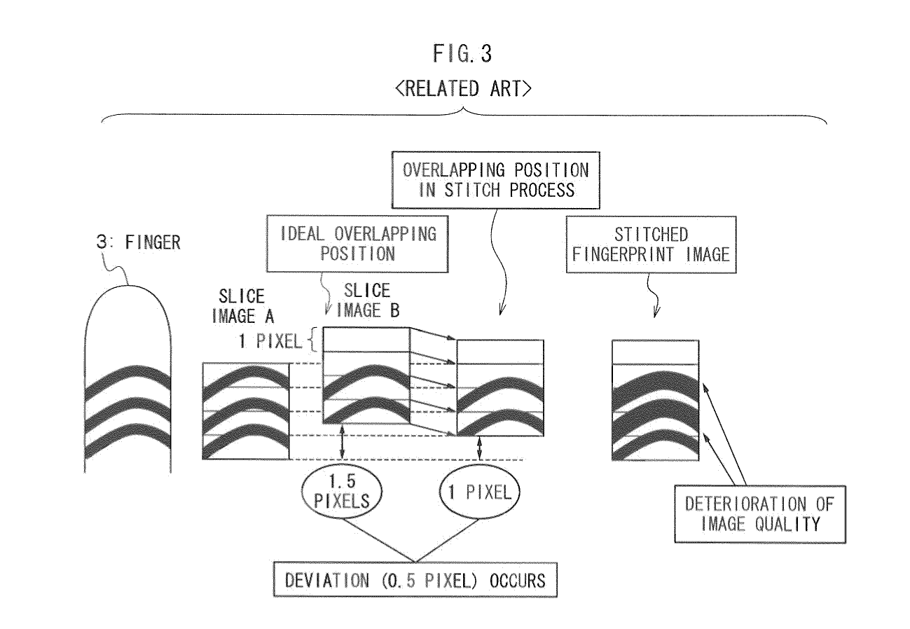

In the technique disclosed in JP-A No. 2003-248820, when the position is searched in the stitch process, the images overlap each other in the units of pixels. Therefore, when the slice images that overlap each other do not deviate from each other by an integer number of pixels, a deviation less than one pixel occurs. The deviation is shown in FIG. 3.

Slice images A and B deviate from each other by 1.5 pixels. When the slice images A and B overlap each other, they overlap each other with a deviation of one pixel or two pixels therebetween, in order to overlap them in the units of pixels. FIG. 3 shows the overlap between the images with a deviation of one pixel therebetween (that is, an ideal overlapping position and an overlapping position in the stitch process). Therefore, the stitched image deviates from the original slice image by 0.5 pixel on the upper and lower sides. The deviation causes deterioration in the quality of the stitched fingerprint image in the overlapping portion. This is because there is a difference between pixel values at the boundary between the valley and ridge of the fingerprint in the overlapping portion.

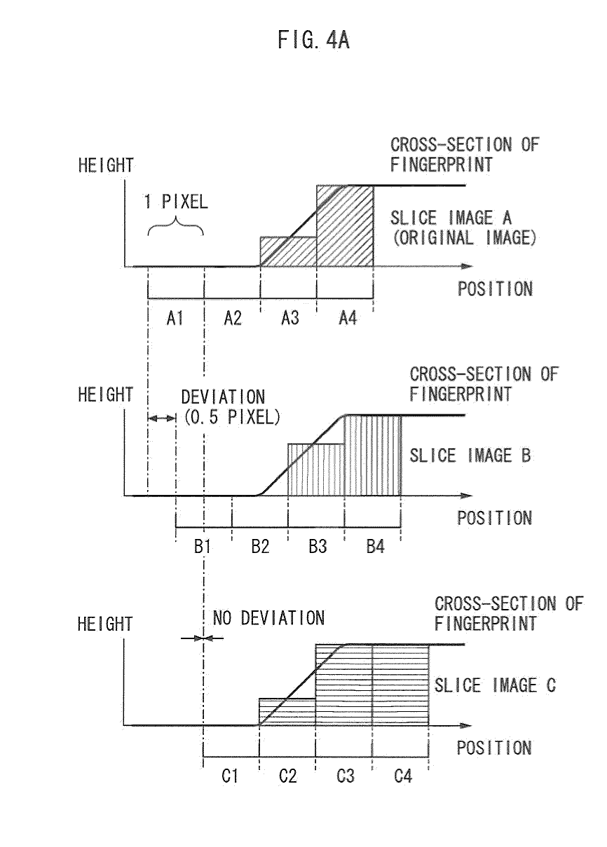

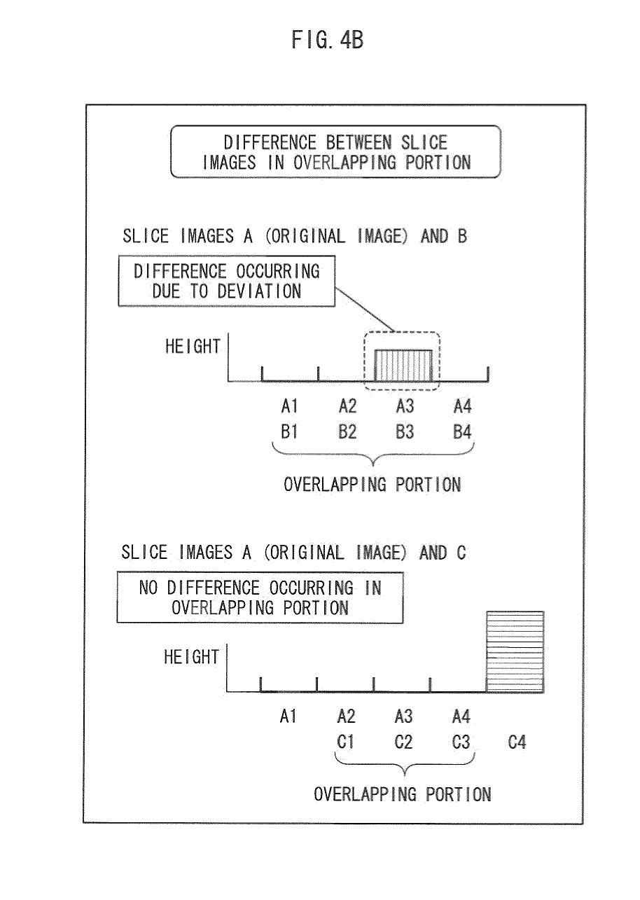

FIGS. 4A and 4B are diagrams illustrating the relationship between the deviation and the difference between the images in the overlapping portion.

FIG. 4A is a diagram illustrating slice images when the cross-section of a fingerprint at the boundary between the valley and the ridge of the fingerprint is sampled in the units of pixels. Slice images A, B, and C are three slice images obtained when the finger 3 slides once. Even when the fingerprints at the same position are sampled, the sampled pixel values are slightly different from each other by the characteristics of the line sensor 1. However, for convenience of description, the difference between the sampled pixel values is neglected. When the slice image A is used as a reference, the slice image B deviates from the slice image A by 0.5 pixel, and the slice image C deviates from the slice image A by one pixel.

FIG. 4B shows the difference between the slice images A and B in an overlapping portion therebetween and the difference between the slice images A and C in an overlapping portion therebetween. Since the slice image B deviates from the slice image A by 0.5 pixel, a deviation of 0.5 pixel occurs in order to overlap the slice image in the units of pixels, and there is a height difference in the overlapping portion at the boundary between the valley and ridge. Since the slice image C deviates from the slice image A by an integer number of pixels, no deviation occurs when the slice images overlap each other. Therefore, there is no height difference in the overlapping portion at the boundary between the valley and ridge. As a result, when the difference is small, the distance between the overlapping portions of the slice images is close to an integer multiple of the number of pixels, and the deviation therebetween is small.

As such, in the related art, the average of the pixel values of the slice images is calculated and two slice images overlap each other. Therefore, the difference between the pixel values at the boundary between the two slice images due to deviation causes deterioration in the quality of the slice image at the boundary. In addition, the deviation is accumulated whenever a plurality of slice images overlaps each other, which causes deterioration in the quality of the whole fingerprint image.

### First Embodiment

The inventors have proposed the following technique (hereinafter, referred to as the “related technique”) in Japanese Patent Application No. 2008-135069 (not published).

The related technique relates to a decimation technique for decimating a predetermined number of slice images input from a line sensor and inputting the other slice images to a stitch process.

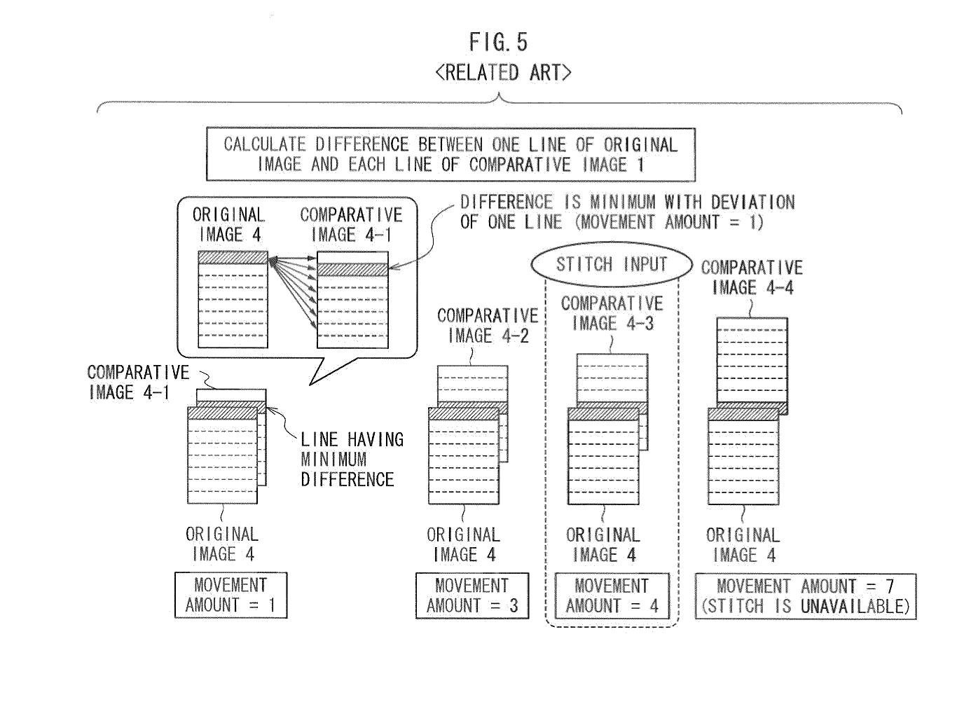

FIG. 5 is a diagram illustrating the outline of a decimation process accordimg to the related technique.

Two slice images, that is, a slice image (original image) used in the previous stitch process and a slice image (comparative image) newly input from the line sensor are used to calculate a movement amount between the slice images. A slice image having the largest movement amount in the range in which the stitch process can be performed is input to the stitch process. The difference between one line of the original image and each line of the comparative images is calculated, and the number of separated pixels in which the minimum difference is obtained is detected. Then, the number of pixels is used as the movement amount between the slice images.

FIG. 5 shows the results in which the movement amount between an original image 4 and a comparative image 4-1 is 1, the movement amount between the original image 4 and a comparative image 4-2 is 3, the movement amount between the original image 4 and a comparative image 4-3 is 4, and the movement amount between the original image 4 and a comparative image 4-4 is 7. Since the movement amount of the comparative image 4-4 is too large to be subjected to the stitch process, the comparative image 4-3 having the largest deviation from the original image among the comparative images 4-1 to 4-3 is input to the stitch process. Since the comparative images 4-1 and 4-2 have a small movement amount, they are decimated without being input to the stitch process. In this way, the number of slice images input to the stitch process is significantly reduced, and the whole image of a fingerprint is constructed.

However, in the related technique, when there is a large deviation between the selected slice images, the amount of deviation accumulated is increased even though a small number of slice images are input to the stitch process.

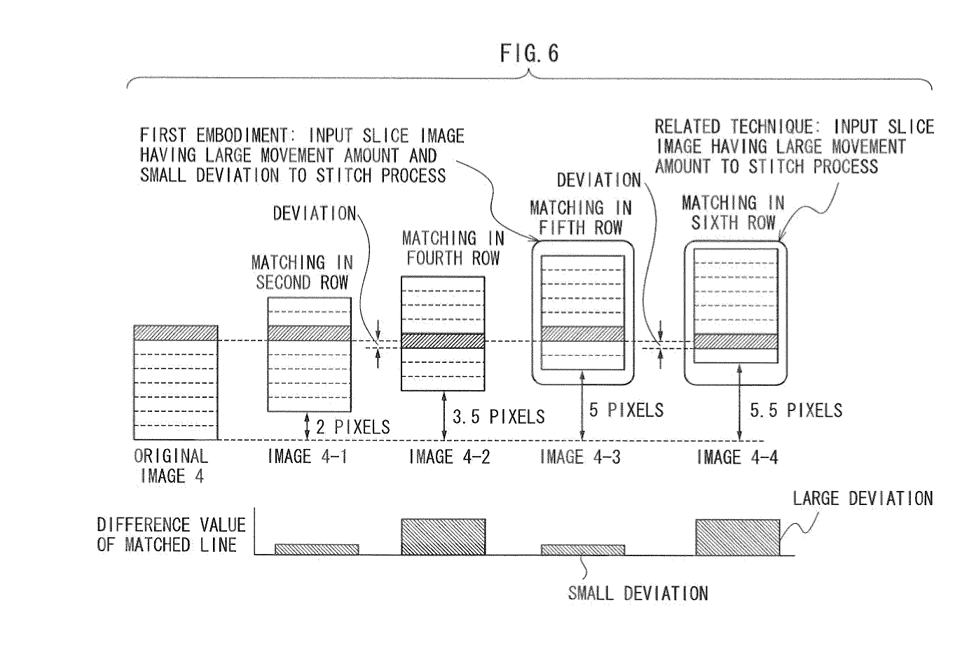

FIG. 6 is a diagram illustrating a method for selecting a slice image.

FIG. 6 shows a method for selecting an image to be input to the stitch process among the images 4-1 to 4-4 that deviate from the original image 4 by a predetermined number of pixels. The images 4-1 and 4-3 deviate from the original image :4 by an integer number of pixels. In this case, there is a small difference between the images when the images overlap each other. The image 4-4 has the largest deviation in the range in which the stitch process can be performed. In the related technique, the image 4-4 having the largest deviation is input to the stitch process. However, in this case, the deviation between the original image 4 and the image 4-4 is large.

(2) Since one line is used to calculate the movement amount, calculation accuracy is lowered.

When the calculation accuracy is lowered, the movement amount is likely to be erroneously calculated. As a result, an error may occur in the determination of decimation and a slice image required for the stitch process is likely to be decimated.

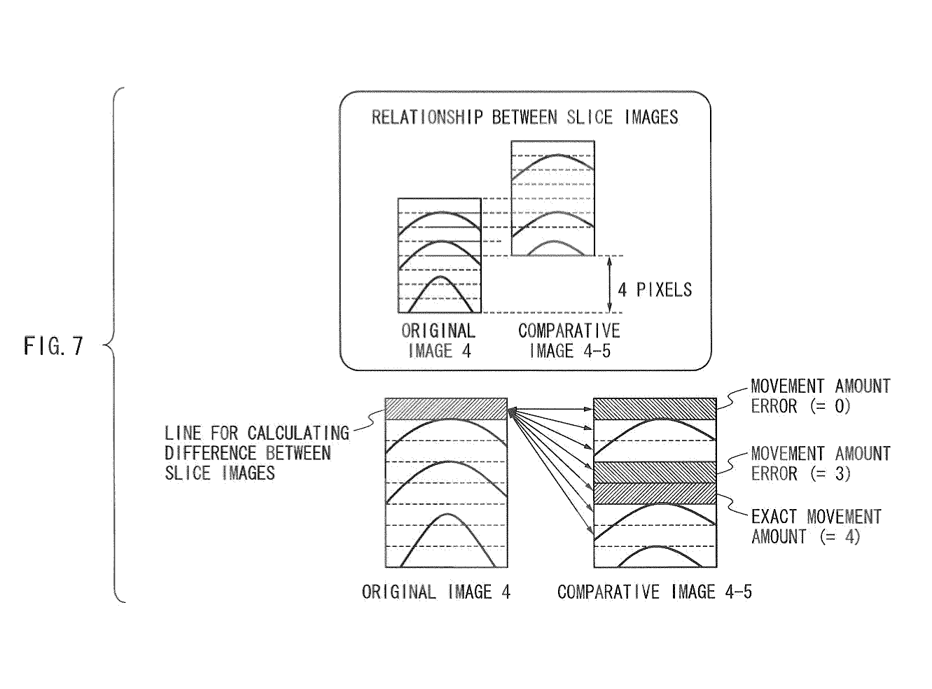

FIG. 7 is a diagram illustrating a method for calculating a movement amount according to the related technique.

FIG. 7 shows a method for calculating a movement amount when a comparative image 4-5 deviates from the original image 4 by four pixels. The difference between the original image 4 and the comparative image 4-5 is calculated while the images deviate from each other one line by one line, and the number of separated pixels where the minimum difference is obtained is detected. Then, the number of pixels is used as a movement amount. In FIG. 7, the zeroth line and third line of the comparative image 4-5 are similar to the fourth line thereof, and the movement amount is likely to be erroneously calculated. That is, when there are similar lines, the movement amount is more likely to be erroneously calculated since one line is used to calculate the movement amount.

(3) When the decimation process is performed with a large movement amount between continuous slice images, the stitch process is likely to fail.

The decimation process according to the related technique is likely to erroneously decimate necessary slice images. When the decimation process is performed with a large movement amount between continuous slice images, the decimation process is likely to erroneously decimate necessary slice images, and the stitch process is likely to fail.

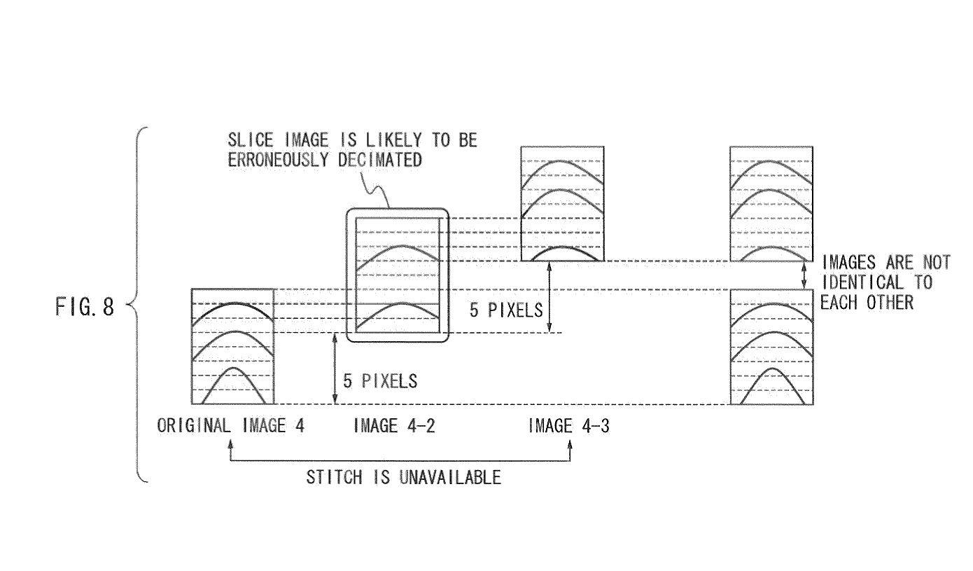

FIG. 8 is a diagram illustrating the decimation process when there is a large movement amount according to the related technique.

The original image 4 and the images 4-2 and 4-3 are slice images that are continuously acquired by the line sensor, and the images 4-2 and 4-3 deviate from the original image 4 at an interval of five pixels. In this case, the image 4-2 is likely to be erroneously decimated by the decimation process. When the image 4-2 is erroneously decimated, the stitch process is likely to fail.

That is, the decimation process is likely to erroneously decimate necessary slice images. Furthermore, when there is a large movement amount between continuous slice images and even one image is decimated, the stitch process is likely to fail.

In the first embodiment of the present disclosure, the following methods (i), (ii), and (iii) are used to solve the above-mentioned problems.

Method for selecting slice images having minimum difference therebetween.

Method for increasing calculation accuracy of movement amount.

Method for preventing failure of stitch process when movement amount is large.

(Fingerprint Reader According to the First Embodiment)

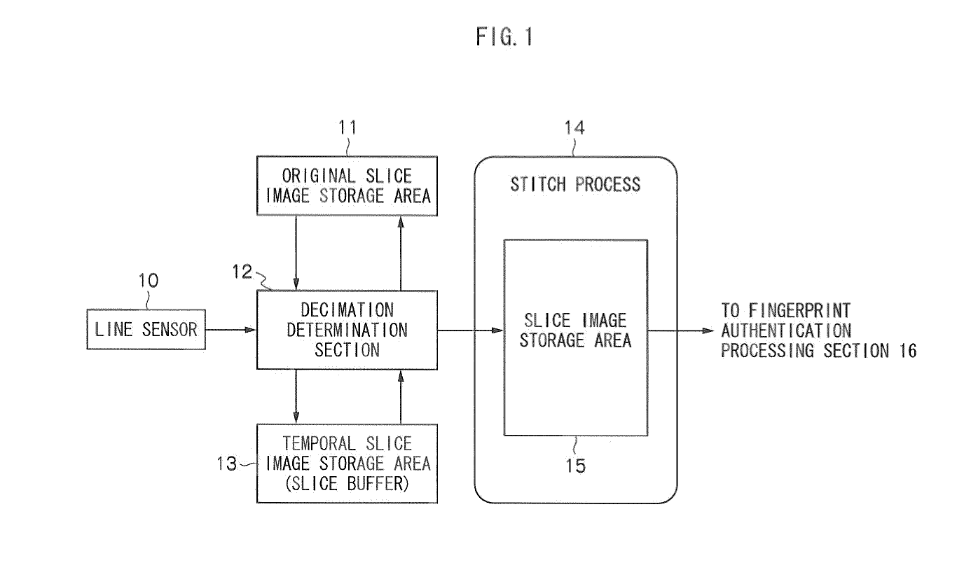

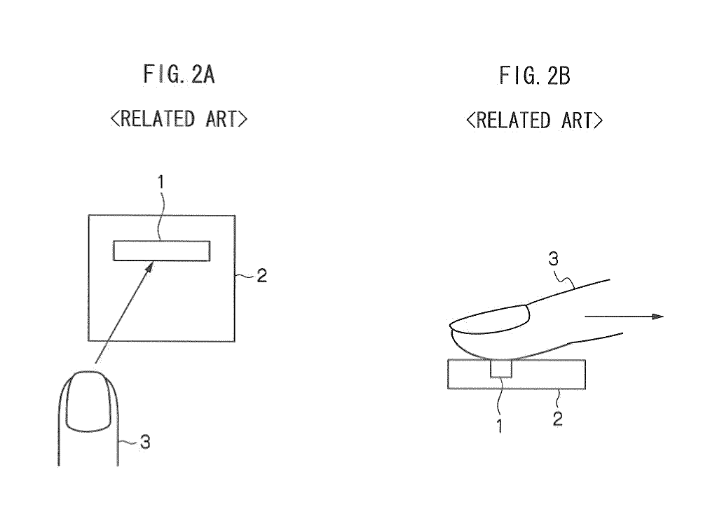

FIG. 1 is a diagram schematically illustrating the structure of a fingerprint reader, which is an image processing apparatus according to the first embodiment of the disclosure.

The fingerprint reader includes a line sensor 10 that acquires the continuous slice images of a fingerprint and a first storage section (for example, an original slice image storage area) 11. A decimation determination section 12 is connected to the line sensor 10 and the original slice image storage area 11. A second storage section (for example, a slice buffer in a temporary slice image storage area) 13 and a slice image storage area 15 in a stitch processing section 14 are connected to the decimation determination section 12.

The original slice image storage area 11 stores the same image as the slice image previously stored in the slice image storage area 15, and is configured with, for example, a random access memory (hereinafter, referred to as a “RAM”). The decimation determination section 12 has the functions of an image movement amount calculation section, a determination section, and first and second mode change sections, and determines whether to store the slice image input from the line sensor 10 in the slice image storage area 15. For example, the decimation determination section 12 is configured with, for example, a central processing unit (hereinafter, referred to as a “CPU”) that is controlled based on a program stored in a read only memory (hereinafter, referred to as a “ROM”). The slice buffer 13 stores the slice image that has been determined to be temporarily stored by the decimation determination section 12, and is configured with, for example, a RAM.

The stitch processing section 14 uses the slice images stored in the slice image storage area 15 configured with, for example, a RAM to reconstruct one whole fingerprint image (stitch process), and is configured with, for example, a CPU. The fingerprint image generated by the stitch processing section 14 is transmitted to the fingerprint authentication processing section 16, and the fingerprint authentication processing section 16 authenticates whether the fingerprint image is identical to fingerprint data of a user that has been previously registered.

(Fingerprint Reading Method According to First Embodiment)

A fingerprint reading method using the fingerprint reader according to the first embodiment includes the following three processes (1), (2), and (3).

Process of inputting slice images having the minimum difference therebetween to a stitch process.

Process of comparing slice images using lines separated from each other in an overlapping portion therebetween.

Process of changing an operation mode to a non-decimation mode when there is a large movement amount between continuous slice images.

First, the decimation determination section 12 performs the process (1). Then, the deviation when the stitch process is performed is reduced, as compared to when a slice image having the largest deviation is input to the stitch process.

In the first embodiment, in the method for selecting the slice image shown in FIG. 6, the slice images having the minimum difference therebetween are input to the stitch processing section 14. In this way, deviation occurring when two slice images overlap each other can be reduced.

Actually, there is a minute difference between the images that deviate from each other by an integer number of pixels due to the characteristics of the line sensor 10. Therefore, when the slice image having a small movement amount is continuously input to the stitch processing section 14, the deviation occurring when the slice images overlap each other is reduced, however the overall amount of deviation accumulated is increased. As:a result, the image quality of the overlapping portion deteriorates. In the: firs embodiment the slice image (image 4-3) having a large movement amount between the slice images and a small deviation in the overlapping portion is input to the stitch processing section 14. In this way, when the movement amount of the slice image is more than a predetermined value, the slice images having the minimum difference therebetween are input to the stitch processing section 14, which can reduce the accumulation of deviation.

Then, the decimation determination section 12 performs the process (2). In this case, the calculation accuracy is improved, as compared to when one line is used to calculate the movement amount.

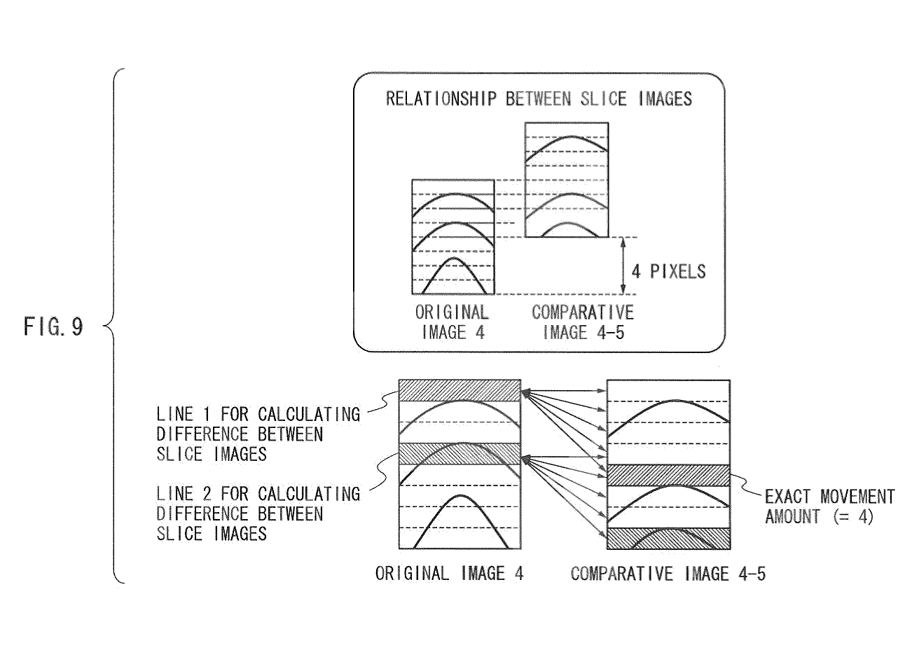

FIG. 9 is a diagram illustrating an example of the method for calculating the movement amount according to the first embodiment which corresponds to FIG. 7 of the related technique.

FIG. 9 is a diagram illustrating the usage of two lines separated from each other in the overlapping portion. The first and third lines of the original image 4 from the upper side and the comparative image 4-5 are compared with each other, while shifting the lines one by one, to calculate a movement amount. The number of separated pixels where the sum of the differences between two lines is the minimum is detected, and the number of pixels is used as the movement amount. Calculation accuracy can be improved by increasing the number of lines of the slice images compared with each other. However, when the number of lines is merely increased, the amount of process is increased. The fingerprint is a set of lines having a certain size, and is characterized in that the difference between adjacent rows is small.

Therefore, for example, in comparison between two lines, when two adjacent lines are selected and the movement amount of one line is erroneously calculated, the movement amount of the other line is likely to be erroneously calculated. As a result, the effect of improving the calculation accuracy is lowered. It is considered that, as the lines to be compared are further away from each other, the correlation between the lines to be compared in one slice image is reduced. In the case in which the correlation between the lines is low, even when the movement amount of one of the two lines separated from each other is erroneously calculated, the-movement amount of the other line is more likely to be exactly calculated.

In the first embodiment, when the movement amount is calculated, the lines separated from each other in the overlapping portion are considered. Therefore, the calculation accuracy can be effectively improved. That is, since two lines separated from each other in the overlapping portion are used to calculate the movement amount, the movement amount is more likely to be exactly calculated.

The decimation determination section 12 performs the process (3) to prevent the failure of the stitch process due to an error in the decimation of the slice image.

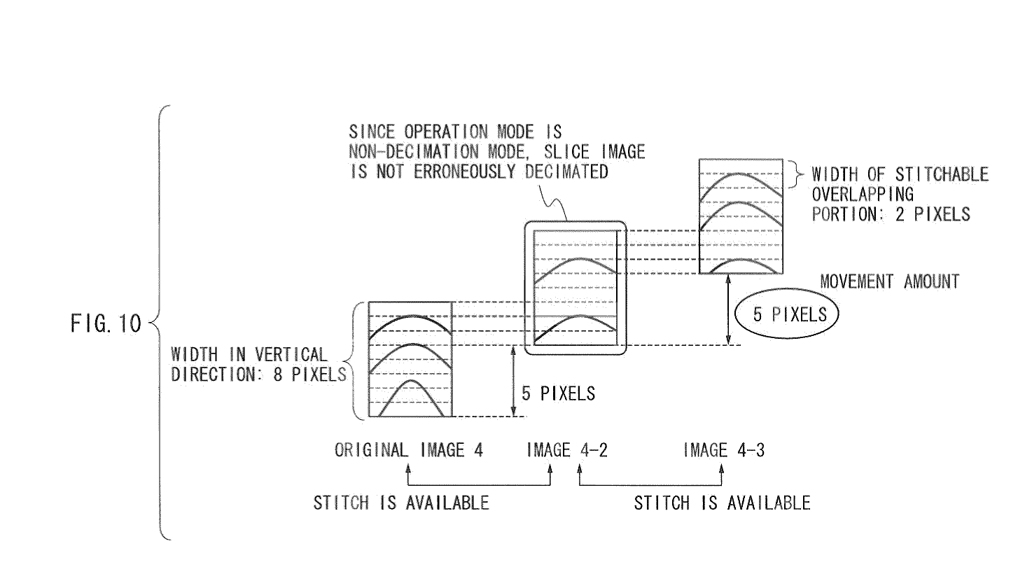

FIG. 10 is a diagram illustrating the decimation process when there is a large movement amount in the first embodiment, which corresponds to FIG. 8 of the related technique.

In FIG. 10, the original image 4 and the images 4-2 and 4-3 are slice images that arc continuously acquired by the line sensor 10. FIG. 10 shows the mode in which the decimation process is not performed when the movement amount between continuous slice images is large (for example, when the movement amount is 5). The conditions of the non-decimation mode are as follows:

The movement amount between the slice images>½{(the width of the slice image in the vertical direction)−(the width of an overlapping portion that can be stitched}.

For example, the movement amount between the slice images is 5, the width of the slice image in the vertical direction is 8, and the width of the overlapping portion that can be stitched is 2.

A large variation in the movement amount between continuous slice images hardly occurs. Therefore, when a movement amount that is more than 3, which is half the maximum movement amount 6 where the stitch process does not fail (8−2 (the width of the slice image in the vertical direction−the width of the overlapping portion that can be stitched)=6), is detected, the movement amount of the next acquired slice image is likely to be more than 3. Even when one image is decimated, the stitch process fails. Therefore, it is preferable not to perform the decimation process.

In the first embodiment, the operation mode is switched to the non-decimation mode when the movement amount between the slice images is large and the stitch process fails due to the decimation of even one image, in addition to when the state of the movement amount 5 is continuous. In the non-decimation mode, all the images until it is detected that the slide speed of a finger is certainly lowered, for example, the slice images having a small movement amount that are continuously acquired are input to the stitch processing section 14.

In this way, the failure of the stitch process due to a decimation error when the movement amount is large can be prevented. In addition, in the non-decimation mode, when the slice images having a small movement amount are continuously acquired, the operation mode is switched to a mode in which the decimation process is performed. In this way, it can respond to the case in which the moving speed of a finger is not constant.

(Decimation Process According to First Embodiment)

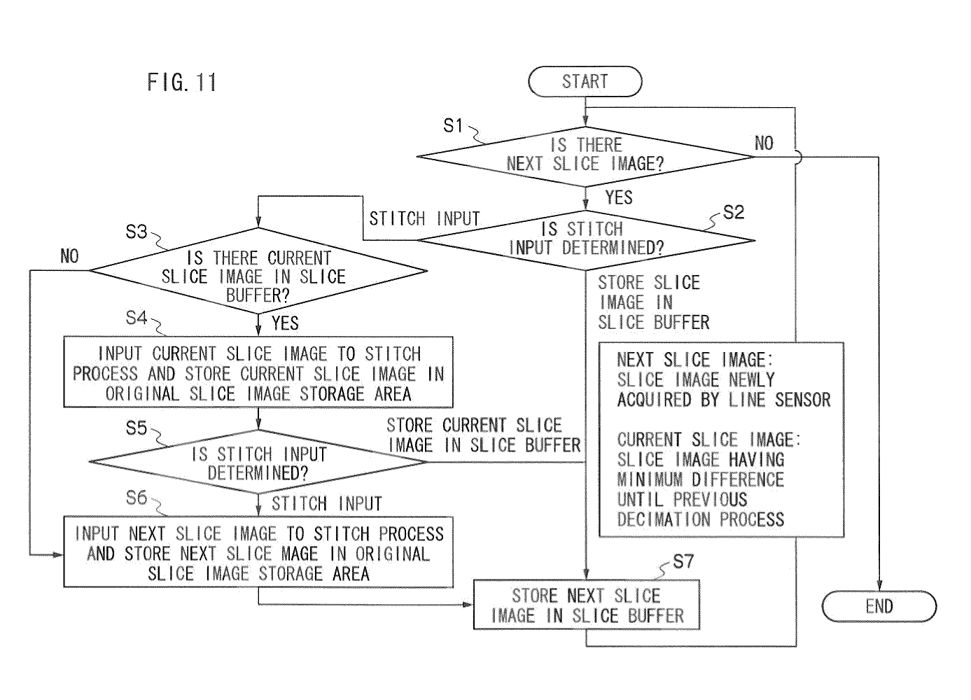

FIG. 11 is a flowchart illustrating the decimation process of the fingerprint reader shown in FIG. 1.

The detailed decimation process performed by the decimation determination section 12 for achieving the following three points (1), (2), and (3) will be described below.

First, in Step S1, the decimation determination section 12 checks whether there is a slice image (next slice image) newly acquired by the line sensor 10. If it is determined that there is the next slice image, in Step S2, the decimation determination section 12 determines a stitch input. The previous slice image stored in the original slice image storage area 11 (that is, the slice image previously input to the stitch processing section 14) and the next slice image are used for the stitch input determination. As a result of the stitch input determination, when the next slice image is stored in the slice buffer 13, in Step S7, the decimation determination section 12 stores the next slice image in the slice buffer 13 and returns to Step S1.

As a result of the stitch input determination, when the next slice image is input to the stitch processing section 14, in Step S3, the decimation determination section 12 checks whether there is a slice image (the current slice image) stored in the slice buffer 13 by the previous decimation process. If it is determined that there is the current slice image stored in the slice buffer 13, in Step S4, the decimation determination section 12 inputs the current slice image stored in the slice buffer 13 to the stitch processing section 14 and stores the current slice image in the original slice image storage area 11.

Then, in Step S5, the decimation determination section 12 uses the current slice image and the next slice image to perform stitch input determination. If it is determined in Step S5 that the current slice image is stored in the slice buffer 13, in Step S7, the decimation determination section 12 stores the next slice image in the slice buffer 13. On the other hand, it is determined that the stitch input is performed, in Step S6, the decimation determination section 12 inputs the next slice image to the stitch processing section 14 and stores the next slice image in the original slice image storage area 11.

(Stitch Input Determination in Decimation Process)

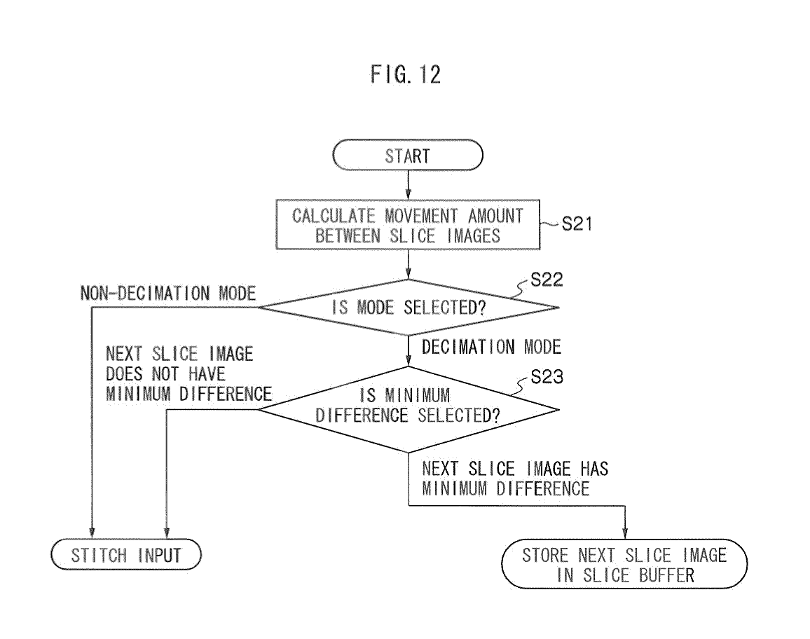

FIG. 12 is a flowchart illustrating the procedure of the stitch input determination (Step S2) in the decimation process shown in FIG. 11.

Next, processes corresponding to three points (1), (2), and (3) of the first embodiment will be described in the order of (2), (3), and (1) with reference to the flowchart shown in FIG. 12.

Process of comparing slice images using lines separated from each other in an overlapping portion (point (2)).

According to the second point (2) of the first embodiment, in Step S21, two images, that is, the slice image stores in the original slice image storage area 11 and the next slice image are used to calculate the movement amount between the slice images.

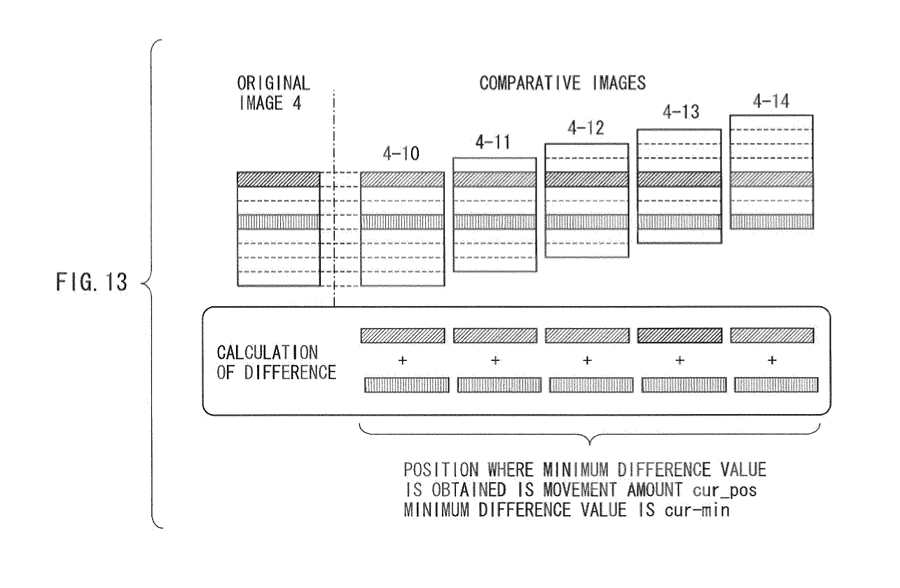

FIG. 13 is a diagram illustrating a method for calculating a movement amount between two slice images (Step S21) in the flowchart shown in FIG. 12.

The decimation determination section 12 calculates the difference between two lines in an overlapping portion between the original image 4 and each of the comparative images 4-10 to 4-14 from the state in which the original image 4 and each of the comparative images completely overlap each other (the images deviate from each other by 0 pixel) (the comparative image 4-10) to the state in which two lines to be compared overlap each other while being separated from each other by a certain distance (by four pixels in FIG. 13 (the comparative image 4-14)). The differences of the two lines are added, and the number of pixels having the minimum difference in the comparative images (the comparative images 4-10 to 4-14) deviating from the original image by 0 to 4 pixels is used as the movement amount. For example, as a result of the addition of the differences of the two lines, when the comparative image (the comparative image 4-13) deviating from the original image by three pixels has the minimum difference, a movement amount cur_pos is 3. A minimum difference value cur_min is used in a process of selecting the minimum difference (Step S23).

For example, a method for calculating the sum of the absolute values of differences is used to calculate the difference between the slice images in an overlapping portion therebetween, however the invention is not limited thereto. Any method may be used as long as it can calculate the difference between the slice images.

(b) Process of changing the operation mode to a non-decimation mode when a movement amount between continuous slice images is large (point (3)).

The third point (3) of the first embodiment is used to perform mode selection in Step S22 of FIG. 12. When the non-decimation mode is selected, the current slice image stored in the slice buffer 13 or the next slice image is input to the stitch processing section 14. When the decimation mode is selected, decimation is performed in the subsequent process.

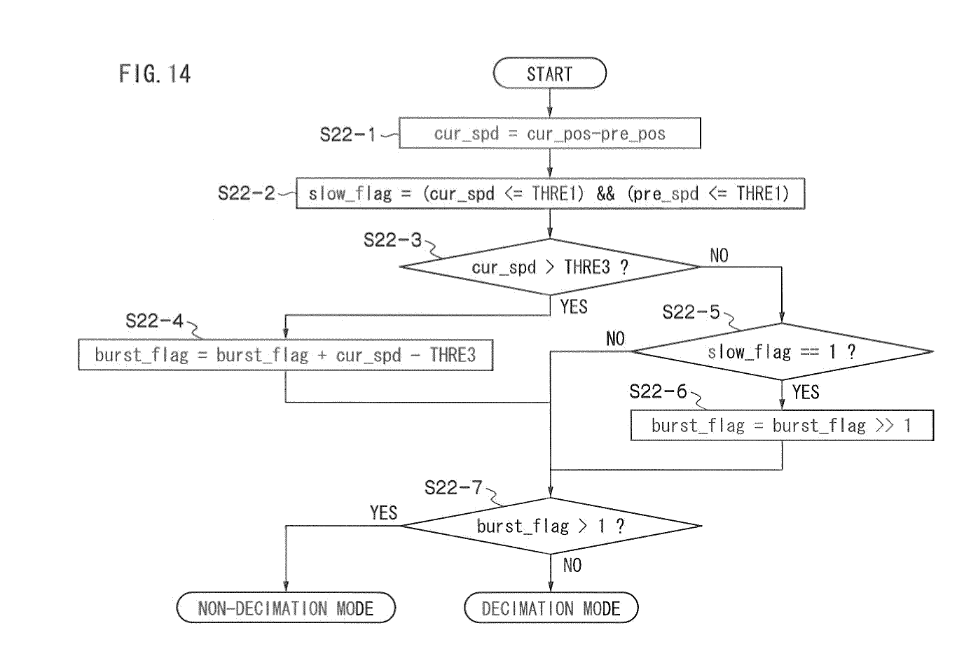

FIG. 14 is a flowchart illustrating the procedure of the mode selection (Step S22) in FIG. 12.

In the mode selection, first, in Step S22-1, the moving speed cur_spd of a finger is calculated. The moving speed cur_spd is calculated based on the movement amount cur_pos calculated in Step S21 of FIG. 12 and a movement amount pre_pos calculated by the previous decimation process. In Step S22-2, a flag slow_flag indicating that the moving speed is lowered is set. The flag slow_flag is established when the moving speed cur_spd calculated by the current decimation process and the moving speed pre_spd calculated by the previous decimation process are a threshold value THRE1 or less for determining the lowering of the moving speed.

Then, in Step S22-3, it is checked whether the moving speed cur_spd is more than a threshold value THRE3 for determining that decimation is not performed. If the moving speed cur_spd is more than the threshold value THRE3, in Step S22-4, a flag burst_flag indicating the non-decimation mode is updated. The flag burst_flag is updated to a larger value as the moving speed cur_spd is higher. If the moving speed cur_spd is less than the threshold value THRE3, in Step S22-5, it is checked whether the establishment conditions of the flag slow_flag are satisfied.

If it is checked that the establishment conditions are satisfied, in Step S22-6, the flag burst_flag is shifted one bit to the right and then updated. If it is checked that the establishment conditions arc not satisfied, the flag burst_flag is not updated. Then, in Step S22-7, it is checked whether the flag burst_flag is more than 1. If the flag burst_flag is more than 1, the operation mode is set to the non-decimation mode, and the current slice image or the next slice image is input to the stitch processing section 14. On the other band, if the flag burst_flag is 1 or less, the operation mode is set to the decimation mode.

The threshold values THRE1 and THRE3 may be appropriately set by experiments.

(c) Process of inputting slice images having the minimum difference therebetween to the stitch processing section 14 (point (1)).

The first point (1) of the first embodiment is used to select the minimum difference in Step S23 of FIG. 12. If the minimum difference value of the next slice image is more than the minimum difference value until the previous decimation process, the current slice image or the next slice image is input to the stitch processing section 14. If the minimum difference value of the next slice image is less than the minimum difference value until the previous decimation process, the next slice image is stored in the slice buffer 13.

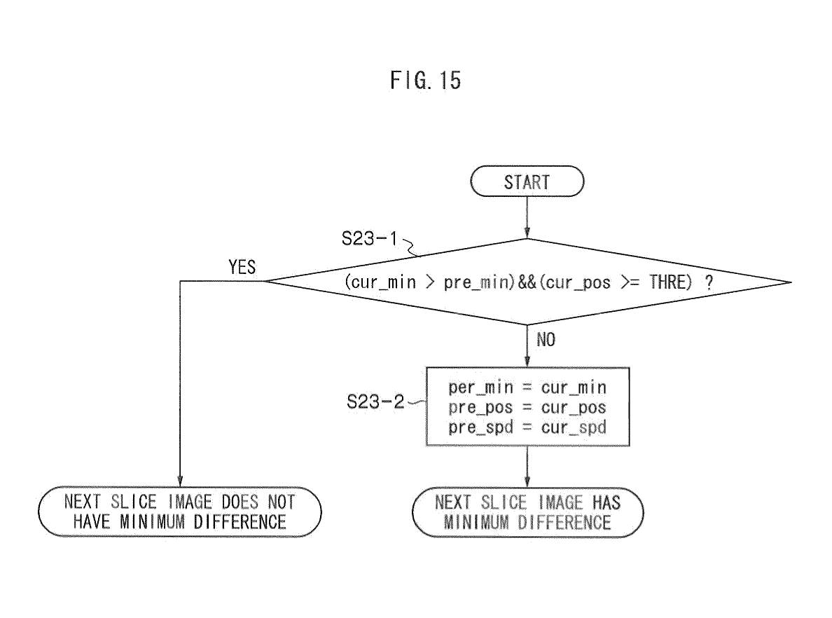

FIG. 15 is a flowchart illustrating the procedure of the minimum difference selection process (Step S23) in FIG. 12.

In Step S23-1, it is checked whether the minimum difference value cur_min when the movement amount is calculated is more than the minimum difference value pre_min until the previous decimation process and whether the movement amount cur_pos is a predetermined threshold value THRE or more for selecting the minimum difference.

When the conditions are satisfied, the minimum difference value of the next slice image is compared with the minimum difference value until the previous decimation process to determine whether the value is the minimum. In this case, since the slice image stored in the slice buffer 13 has the minimum difference value, the slice image stored in the slice buffer 13 is input to the stitch processing section 14.

In contrast, if it is determined in Step S23-1 that the difference value of the next slice image is the minimum, in Step S23-2, the minimum difference value pre_min, the movement amount pre_pos, and the moving speed pre spd until the previous decimation process are updated with the minimum difference value cur_min, the movement amount cur_pos, and the moving speed cur_spd, respectively, and the next slice image is stored in the slice buffer 13.

The threshold value THRE may be appropriately set by experiments.

(Effects of First Embodiment)

According to the first embodiment, the following effects (a), (b), and (c) for the three points (1), (2), and (3) can be obtained.

Effects of process of inputting the slice images having the minimum difference therebetween to the stitch processing section 14 (point (1)).

Since the slice images having the minimum difference therebetween are input to the stitch processing section 14, the deviation between the slice images when they overlap each other is reduced.

A slice image having a small movement amount is not input, and a slice image having the minimum difference among the slice images having movement amounts more than a predetermined value is input to the stitch processing section 14. Therefore, the number of slice images to be input can be reduced, with a small deviation between the slice images when they overlap each other, and reduce the accumulation of deviation.

(b) Effect of process of comparing the slice images using the lines separated from each other in an overlapping portion (point (2)).

Since the slice images are compared using the lines separated from each other in an overlapping portion, calculation accuracy can be effectively improved.

(c) Effects of process of changing the operation mode to the non-decimation mode when the movement amount between continuous slice images is large (point (3)).

Since the operation mode is changed to the non-decimation mode when the movement amount between continuous slice images is large, the failure of the stitch process due to a decimation error can be prevented.

When a small movement amount is continued in the non-decimation mode, the operation mode is changed to the decimation mode. Therefore, it can respond to the case in which the moving speed of a finger is not constant.

(Modifications)

The invention is not limited to the embodiment, and various modifications and changes of the invention can be made. For example, the following modifications and changes (i) and (ii) can be made.

In the first embodiment, the slice image includes eight lines in the vertical direction. However, the number of lines in the vertical direction is not limited to 8, however any number of lines may be used.

In the first embodiment, the slice images of a fingerprint arc used to construct the whole fingerprint image. However, the disclosure may be applied to an image processing method and an image processing apparatus capable of using partial images as well as the fingerprint to construct the whole image.

Following from the above description, it should be apparent to those of ordinary skill in the art that, while the methods and apparatuses herein described constitute exemplary embodiments of the present disclosure and that changes may be made to such embodiments without departing from the scope of the invention as defined by the claims. Additionally, it is to be understood that the invention is defined by the claims and it is not intended that any limitations or elements describing the exemplary embodiments set forth herein are to be incorporated into the interpretation of any claim element unless such limitation or element is explicitly stated. Likewise, it is to be understood that it is not necessary to meet any or all of the identified advantages or objects of the disclosure in order to fall within the scope of any claims, since the invention is defined by the claims and since inherent and/or unforeseen advantages of the present invention may exist even though they may not have been explicitly discussed herein.

What is claimed is:

1. An image processing method for acquiring a partial image of a target and constructing one whole image of the target, comprising:
storing the acquired partial image in a first storage section;
calculating a movement amount of an image using a previous partial image stored in the first storage section and a latest partial image stored in the first storage section;
storing a partial image having a minimum difference from the latest partial image in an overlapping portion therebetween in a second storage section;
determining whether the calculated movement amount is more than a predetermined value; and
storing the partial image having the minimum difference as the latest partial image in the first storage section when it is determined that the calculated movement amount is more than the predetermined value.

2. An image processing method for acquiring a partial image of a target and constructing one whole image of the target, comprising:
storing the acquired partial image in a storage section; and
calculating a movement amount of an image using lines that are separated from each other in an overlapping portion between a previous partial image stored in the storage section and a latest partial image stored in the storage section.

3. An image processing method for acquiring a partial image of a target and constructing one whole image of the target, comprising:
storing the acquired partial image in a first storage section;
calculating a movement amount of an image using lines that are separated from each other in an overlapping portion between a previous partial image stored in the first storage section and a latest partial image stored in the first storage section;
storing a partial image having a minimum difference from the latest partial image in an overlapping portion therebetween in a second storage section;
determining whether the calculated movement amount is more than a predetermined value; and
storing the partial image having the minimum difference as the latest partial image in the first storage section when it is determined that the calculated movement amount is more than the predetermined value.

4. An image processing method for acquiring a partial image of a target and constructing one whole image the target, comprising:
storing the acquired partial image in a storage section;
calculating a movement amount of an image using a previous partial image stored in the storage section and a latest partial image stored in the storage section;
changing an operation mode to a mode that does not perform decimation when the calculated movement amount is more than a predetermined value; and
changing the operation mode to a mode that performs decimation when the movement amount is continuously less than the predetermined value in the mode that does not perform decimation.

5. An image processing method for acquiring a partial image of a target and constructing one whole image of the target, comprising:
storing the acquired partial image in a first storage section;
calculating a movement amount of an image using a previous partial image stored in the first storage section and a latest partial image stored in the first storage section;
changing an operation mode to a mode that does not perform decimation when the calculated movement amount is more than a predetermined value, and storing the acquired partial image as the latest partial image in the first storage section; and
changing the operation mode to a mode that performs decimation when the movement amount is continuously less than the predetermined value in the mode that does not perform decimation, and storing a partial image having a minimum difference from the latest partial image in an overlapping portion therebetween in a second storage section.

6. An image processing method for acquiring a partial image of a target and constructing one whole image of the target, comprising:
storing the acquired partial image in a storage section;
calculating a movement amount of an image using lines that are separated from each other in an overlapping portion between a previous partial image stored in the storage section and a latest partial image stored in the storage section;
changing an operation mode to a mode that does not perform decimation when the calculated movement amount is more than a predetermined value; and
changing the operation mode to a mode that performs decimation when the movement amount is continuously less than the predetermined value in the mode that does not perform decimation.

7. An image processing method for acquiring a partial image of a target and constructing one whole image of the target, comprising:
storing the acquired partial image in a first storage section;
calculating a movement amount of an image using lines that are separated from each other in an overlapping portion between a previous partial image stored in the first storage section and a latest partial image stored in the_first storage section;
changing an operation mode to a mode that does not perform decimation when the calculated movement amount is more than a predetermined value, and storing the acquired partial image as the latest partial image in the first storage section; and
changing the operation mode to a mode that performs decimation when the movement amount is continuously less than the predetermined value in the mode that does not perform decimation, and storing a partial image having a minimum difference from the latest partial image in an overlapping portion therebetween in a second storage section.

8. An image processing apparatus for acquiring a partial image of a target and constructing one whole image of the target, comprising:
a first storage section that stores the acquired partial image;
an image movement amount calculation section that calculates a movement amount of an image using a previous partial image stored in the first storage section and a latest partial image stored in the first storage section;
a second storage section that stores a partial image having a minimum difference from the latest partial image in an overlapping portion therebetween; and
a determination section that determines whether the calculated movement amount is more than a predetermined value, and stores the partial image having the minimum difference as the latest partial image in the first storage section when it is determined that the calculated movement amount is more than the predetermined value.

9. An image processing apparatus for acquiring a partial image of a target and constructing one whole image of the target, comprising:
a storage section that stores the acquired partial image; and
an image movement amount calculation section that calculates a movement amount of an image using lines that are separated from each other in an overlapping portion between a previous partial image stored in the storage section and a latest partial image stored in the storage section.

10. An image processing apparatus for acquiring a partial image of a target and constructing one whole image of the target, comprising:
a first storage section that stores the acquired partial image;
an image movement amount calculation section that calculates a movement amount of an image using lines that are separated from each other in an overlapping portion between a previous partial image stored in the first storage section and a latest partial image stored in the first storage section;
a second storage section that stores a partial image having a minimum difference from the latest partial image in an overlapping portion therebetween; and
a determination section that determines whether the calculated movement amount is more than a predetermined value, and stores the partial image having the minimum difference as the latest partial image in the first storage section when it is determined that the calculated movement amount is more than the predetermined value.

11. An image processing apparatus for acquiring a partial image of a target and constructing one whole image of the target, comprising:
a storage section that stores the acquired partial image;
an image movement amount calculation section that calculates a movement amount of an image using a previous partial image stored in the storage section and a latest partial image stored in the storage section;
a first mode change section that changes an operation mode to a mode that does not perform decimation when the calculated movement amount is more than a predetermined value; and
a second mode change section that changes the operation mode to a mode that performs decimation when the movement amount is continuously less than the predetermined value in the mode that does not perform decimation.

12. An image processing apparatus for acquiring a partial image of a target and constructing one whole image of the target, comprising:
a storage section that stores the acquired partial image;
an image movement amount calculation section that calculates a movement amount of an image using lines that are -separated from each other in an overlapping portion between a previous partial image stored in the_storage section and a latest partial image stored in the storage section;
a first mode change section that changes an operation mode to a mode that does not perform decimation when the calculated movement amount is more than a predetermined value; and
a second mode change section that changes the operation mode to a mode that performs decimation when the movement amount is continuously less than the predetermined value in the mode that does not perform decimation.

13. An image processing apparatus for acquiring a partial image of a target and constructing one whole image of the target, comprising:
a first storage section that stores the acquired partial image;
an image movement amount calculation section that calculates a movement amount of an image using lines that are separated from each other in an overlapping portion between a previous partial image stored in the first storage section and a latest partial image stored in the first storage section;
a first mode change section that changes an operation mode to a mode that does not perform decimation when the calculated movement amount is more than a predetermined value, and stores the acquired partial image as the latest partial image in the first storage section; and
a second mode change section that changes the operation mode to a mode that performs decimation when the movement amount is continuously less than the predetermined value in the mode that does not perform decimation, and stores a partial image having a minimum difference from the latest partial image stored in the first storage section in an overlapping portion therebetween in a second storage section.
